(19) United States
(12) Patent Application Publication
(10) Pub. No.: US 2023/0188175 A1
(43) Pub. Date: Jun. 15, 2023

(54) CHIPSET AGNOSTIC FRONT-END MODULE FOR DIGITAL PRE-DISTORTION

(71) Applicant: Danger Devices, Inc., Menlo Park, CA (US)

(72) Inventors: Sehat Sutardja, Las Vegas, NV (US); Nick Sutardja, Menlo Park, CA (US); Cheng-Hui Lin, Menlo Park, CA (US); Ahmad Abdelmajid, Menlo Park, CA (US); George Nohra, Menlo Park, CA (US)

(21) Appl. No.: 17/988,671

(22) Filed: Nov. 16, 2022

Related U.S. Application Data
(60) Provisional application No. 63/280,537, filed on Nov. 17, 2021.

(51) Int. Cl. H04B 1/44; H04B 1/04

(52) U.S. Cl. CPC H04B 1/44; H04B 1/04; H04B 2001/0408

(57) ABSTRACT

A front-end module, compatible with various baseband chipset configurations, that includes a transmit signal path having a transmit amplifier, to amplify an outgoing signal, and a coupler. The coupler diverts a first portion of the outgoing signal, to a transmit-receive switch, a second portion to a receive path switch, and a third portion to a RF-coupling port. As included is a receive signal path including a low-noise amplifier, configured to receive an incoming signal, and a receive path switch. The receive path switch receives the incoming signal, from the transmit-receive switch, and the second portion of the outgoing signal from the coupler. The receive signal path also includes a receive port configured to selectively receive, through the receive path switch, incoming signals from an antenna and the second portion of the outgoing signal. A RF coupling port connects to the coupler to receive the third portion of the outgoing signal.

### 1. FIELD OF THE INVENTION

The innovation relates to front-end modules and in particular to a method and apparatus for universal front-end module.

### 2. RELATED ART

Power amplifiers (PAs) or front-end modules are one of the most critical components in modern day communication systems. Power amplifiers increase the magnitude of a signal from the baseband chipsets before feeding the signals to the antennas for wireless transmission. Amplifiers usually consume a large amount of current and generate heat that can adversely impact performances of the overall system, increase cost of heat mitigation and the size of the overall solution. As a result, scientists and engineers have been looking for techniques to lower power consumption while maintaining or improving overall system performance.

Digital predistortion is a widely used technique to reduce heat and power consumption in front-end modules. In some applications, digital pre-distortion can reduce power consumption by as much as 50%, which is a significant improvement.

To implement digital pre-distortion, front-end modules employ feedback mechanisms (for example radio frequency (RF) couplers) to sample the output waveform from the front-end module and send the signal back to the baseband chipset for further signal processing. Different baseband chipsets utilize different coupling mechanisms. To be compatible with different baseband chipsets, front-end module vendors must design and manufacture multiple different digital pre-distortion capable front-end modules, each having several variations which require redundant efforts and extra resources. This is a drawback in the prior art and results in additional costs, delays, and complexity.

FIGS. 1A, 1B, and 1C illustrate various prior art chipset signs. FIG. 1A illustrates a chipset which uses a dedicated coupling port. FIG. 1B and FIG. 1C illustrate chipsets which do not have a dedicated coupling port, but instead reuse the receive port for sampling the output waveforms from the front-end module. As a result, there are two or more different types of chipsets available in the market, often made and sold by different companies. For digital pre-distortion capable front-end modules (see FIGS. 1A, 1B and 1C) to be compatible with a particular type of chipset, it must be uniquely configured to be compatible with that particular chipset. As a result, front-end modules must be configured differently depending on the type of digital pre-distortion chipset with which it will be paired. This adds complexity and costs, as well as increased design time, cost, and manufacturing delays because multiple different front-end modules must be created depending on the type of digital pre-distortion chipset, to which the front-end module will be paired.

FIG. 1A is a diagram illustrating a digital pre-distortion baseband chipset with a dedicated RF coupling port paired with a digital pre-distortion front-end module with a built-in RF coupler. In this combination, output signals from the amplifier go through the RF coupler and reach the RF-CPL port. The coupled RF signals are sent to the chipset for signal processing. Transmit and receive windows are controlled by a s switch 128, which connects to an antenna port 132. The overall coupling coefficient is designed precisely on the RF coupler.

FIG. 1B is a diagram illustrating a digital pre-distortion baseband chipset without a dedicated RF coupling port paired with a digital pre-distortion front-end module. In this combination, output signals from the amplifier leak through the transmit/receive (T/R) switch and the low noise amplifier (LNA) and reaches the receive (RX) port for the digital pre-distortion baseband chipset. Since the RF signal leakage is unintentional, the overall coupling coefficient is difficult to control.

FIG. 1C is a diagram illustrating a similar approach as FIG. 1B. However, in FIG. 1C, output signals from the amplifier go through a built-in directional coupler with a well-defined coupling coefficient, then through the switch in front of the RX port. The coupled RF signals are then fed to the chipset for signal processing. The switch in front of the RX port is needed to isolate the coupled signals in the transmit (TX) mode from the received signals in RX mode.

A prior art RF coupler is shown in FIG. 2A. This example embodiment of a prior art coupler has an RF input port, an RF through port, an isolated port, and a coupler port. The single coupling port can be used to sense output signals from the power amplifier and would be used with the baseband chipset shown in FIG. 1A.

### SUMMARY

The innovation disclosed below proposes a universal digital pre-distortion capable front-end module design, with dual RF coupling ports, which is compatible with numerous different digital pre-distortion baseband chipsets, including radio frequency front-end modules. This overcomes the drawbacks of the prior art which requires different front-end module designs depending on the type of chipset with which it will be paired.

As discussed below in detail, a front-end module can include a multi-stage power amplifier (PA), transmit/receive switch (TX/RX SW), single or multi-stage low noise amplifier (LNA) with bypass function, dual RF, and a notch filter at the transmit port before the power amplifier (PA), and a notch filter at the receive port before or after the low noise amplifier (LNA).

In addition, the proposed digital pre-distortion front-end module also supports the following important functions.

(1) A built-in logarithmic (LOG) power detector which provides voltage that is proportional to the output power readings for accurate transmit signal strength indicator (TSSI) calibration. This LOG power detector pin is denoted as “V-DET” in FIG. 3A and FIG. 3B.

(2) 2-pin (Table 1A) or 3-pin (Table 1B) logic control, discussed below in more detail.

To overcome the drawbacks of the prior art, disclosed is a front-end module for use with a baseband chipset. In one embodiment, the module includes an antenna port configured to connect to an antenna and a transmit-receive switch configured to connect to the antenna port. The module includes a transmit signal path that comprises an input port configured to receive an outgoing signal, a transmit amplifier configured to amplify the outgoing signal, and a coupler. The coupler is configured to divert a first portion of the outgoing signal to a transmit-receive switch, a second portion of the outgoing signal to a receive path switch, and a third portion of the outgoing signal to a RF-coupling port. Also part of the module is a receive signal path comprising a low noise amplifier configured to receive an incoming signal from the transmit-receive switch, and a receive path switch. The receive path switch is configured to receive the incoming signal from the transmit-receive switch and the second portion of the outgoing signal from the coupler. Also part of the receive signal path is a receive port, connected to the receive path switch, configured to selectively receive an incoming signal from the transmit-receive switch and the second portion of the outgoing signal. A RF coupling port connects to the coupler to receive the third portion of the outgoing signal.

In one configuration, the coupler has an input, RF through output, a RF coupling port output, a receive path switch output, and at least one RC network. In one embodiment, the second portion of the outgoing signal is a different magnitude than the third portion of the outgoing signal. It is contemplated that the receive path switch may comprise a single pole, double throw switch. The disclosed front-end module is compatible with baseband chipsets that have a coupling port and baseband chipsets that do not have a coupling port. It is contemplated that receive path switch will selectively provide the second portion of the outgoing signal to the receive port when the front-end module is connected to a baseband chipset that does not have a coupling port. The module may further comprise a controller configured to provide control signals to the receive path switch and the transmit-receive switch.

Also disclosed is a method for coupling an outgoing signal in a front-end module to a baseband chipset. In one embodiment, this method includes receiving an outgoing signal at a transmit port of the front-end module and amplifying the outgoing signal to create an amplified signal. Then, processing the amplified signal with a coupler to generate an antenna signal, a RF coupling port signal and a receive port switch signal. The antenna signal is provided to a transmit-receive switch configured to selectively switch the antenna signal to an antenna. The RF coupling port signal is provided to a RF coupling port of the front-end module, such that the RF coupling port is configured to provide the RF coupling port signal to a baseband chipset configured to receive an RF coupling port signal. The receive port switch signal is provided to a receive port switch, such that the receive port switch signal is configured to selectively provide the receive port switch signal or an incoming signal to a receive port of the front-end module.

In one embodiment, the method further comprises generating control signals that control switch positions of the transmit-receive switch and the receive port switch. To expand compatibility, for baseband chipsets that have a baseband chipset coupling port, the RF coupling port of the front-end module is connected to the baseband chipset coupling port and for baseband chipsets that do not have a coupling port, the receive port of the front-end module connects to a baseband chipset receive port. In one embodiment, the coupler has an input port, a pass through port, a RF coupling port, and a receive path switch port. It is contemplated that the coupler includes an RC network.

Also disclosed is a front-end module compatible with two or more different baseband chipsets. In one embodiment, this front-end module includes a transmit port configured to receive a transmit signal from a baseband chipset. The transmit signal is to be transmitted from the front-end module. A coupler is configured to receive the transmit signal or a modified version of the transmit signal and divert a first portion to a transmit-receive switch, connecting to an antenna, divert a second portion to an RF coupling port as an RF coupling port signal, divert a third portion to a receive path switch. The receive path is configured to carry a received signal, which was received over the antenna. Also part of the module is a RF coupling port configured to receive the RF coupling port signal from the coupler. A receive port is provided as part of the module and is configured to selectively present the received signal from the antenna, after processing by the frond-end module, to the baseband chipset. The receive port also presents the second portion, from the coupler to the baseband chipset.

In one embodiment, the coupler has an input, and three outputs, such that two of the outputs have different coupling coefficients. In one configuration, a receive path that connects to the receive port includes a receive path switch and a low noise amplifier. The receive path switch connects to the coupler and the low noise amplifier, and the low noise amplifier is configured to amplify the received signal. As discussed herein the front-end module is compatible with a baseband chipset that has or does not have a baseband chipset coupling port. In one embodiment, the coupler includes an RC network. The module may further comprise a controller configured to provide switch control signals to the receive path switch and the transmit-receive switch.

Other systems, methods, features and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A illustrates an exemplary digital pre-distortion baseband chipset with a dedicated RF coupling port paired with a digital pre-distortion front-end module with a built-in RF coupler.

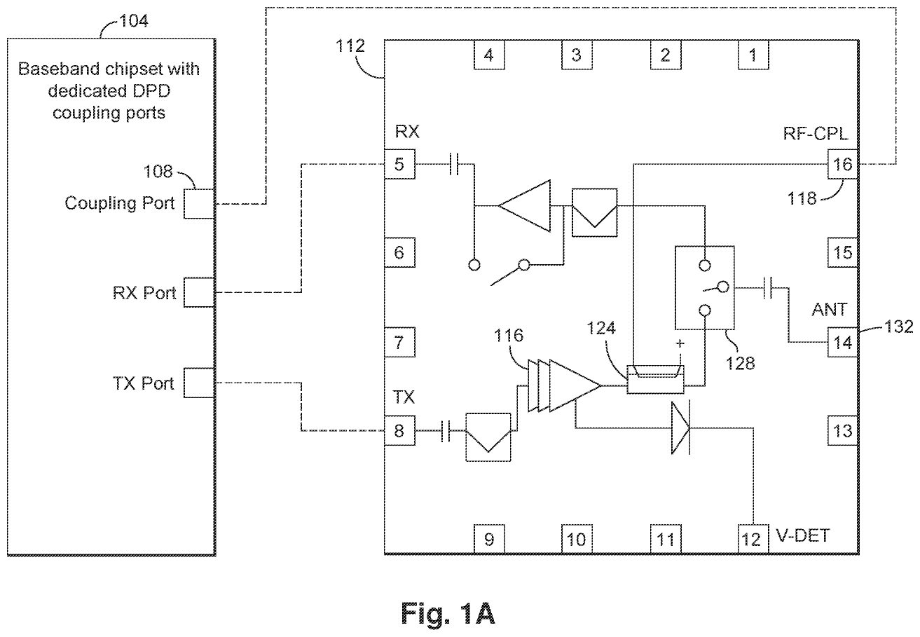

FIG. 1B illustrates an exemplary baseband chipset without a dedicated RF coupling port paired with a digital pre-distortion front-end module.

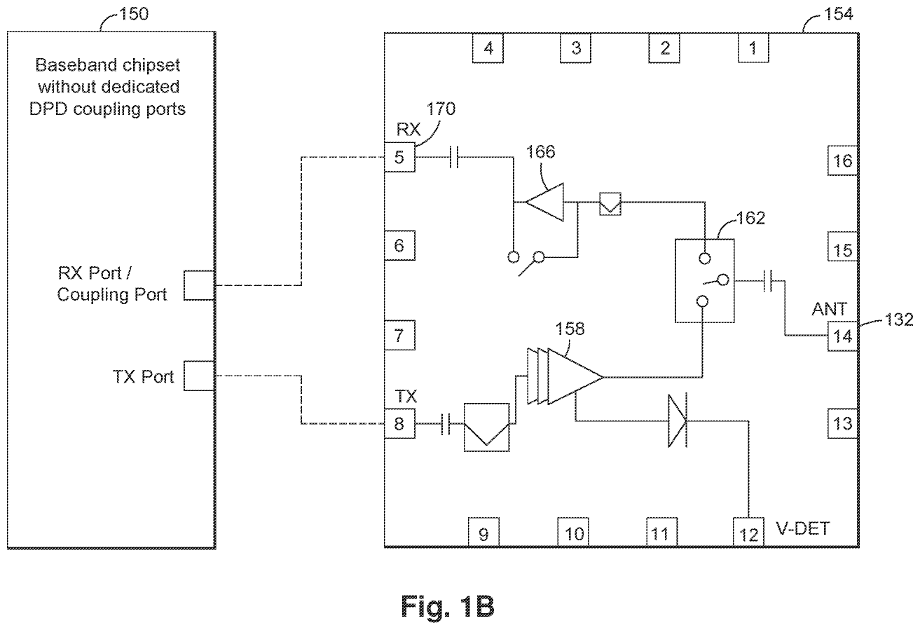

FIG. 1C illustrates an exemplary digital pre-distortion baseband chipset with a built-in directional coupler.

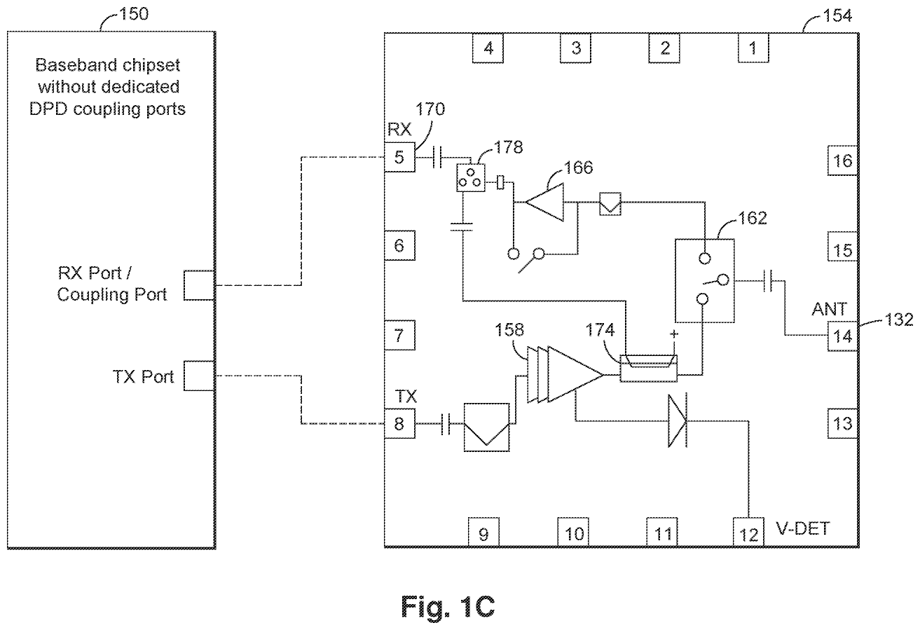

FIG. 2A illustrates an exemplary prior art single port coupler.

FIG. 2B is a diagram illustrating an example embodiment of a dual-coupling port coupler used in the proposed digital pre-distortion front-end module.

FIG. 3A is an example embodiment of the proposed front-end module paired with a digital pre-distortion baseband chipset with a dedicated RF coupling port.

FIG. 3B is an example embodiment of the proposed front-end module paired with a digital pre-distortion baseband chipset that reuses the RX port as the coupling port.

### DETAILED DESCRIPTION

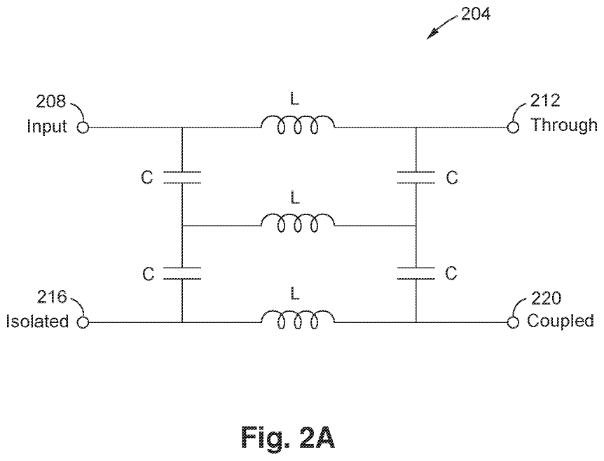

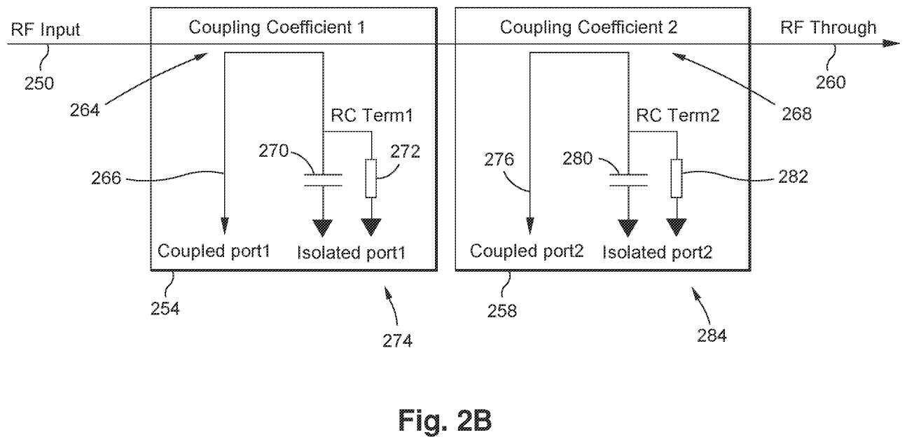

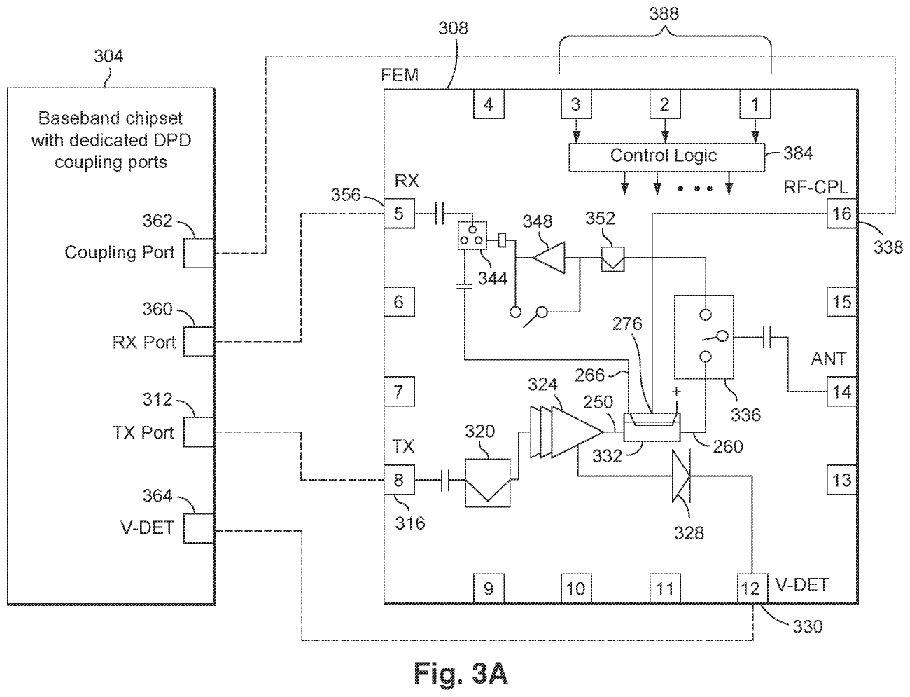

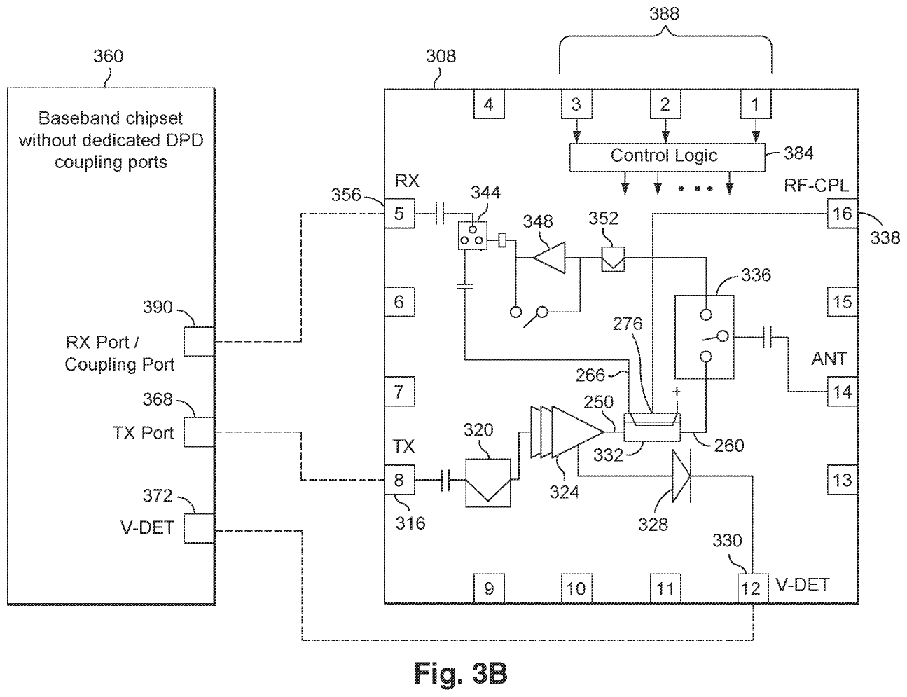

This innovation proposes a new coupler design with dual coupling ports (FIG. 2B). In general, the two coupling ports can have different coupling coefficients for different coupling mechanisms. This new design can work with chipsets with a dedicated coupler port or reuse the RX port (FIG. 3A and FIG. 3B)

FIG. 2B is an example embodiment of a dual-coupling port RF coupler used in the proposed digital pre-distortion front-end module. In this embodiment, an input 250 is provided to receive a signal, such as a radio frequency signal. The input connects to a first coupling module 254. The first coupling module 254 also connects to a second coupling module 258, which in turn connects to an RF through port 260.

The first coupling module 254 includes a first coupler 264, which may be a transformer or other similar inductive coupling device. Extending from the first coupler 264 are two branches. One branch includes a first coupling port 266 and the other branch includes a capacitor 270 and resistor 272 which are part of a first isolation port.

The second coupling module 258 is configured generally similar to the first coupling module 254 with the second coupler 268 having two branches. One branch includes a second coupling port 276 and the other branch includes a capacitor 280 and resistor 282 which are part of a second isolation port 284. The first isolated port 274 and the second isolated port 284 may comprise a RC termination network, and in other embodiment, other termination configurations are possible, that may include one or more resistor, capacitor, inductors or other active or passive elements.

The coupling factor, resistance, and capacitance of the elements of the second coupling module 258 may be the same or different from the first coupling module 254. In the embodiment shown herein, the coupling coefficient or factor for the first coupling module 254 is different than the coupling coefficient for the second coupling module 258. As a result, the amount of energy output from the coupling modules 254, 258 is different thereby suiting the particular baseband module with which the front-end module is paired. The coupling factor is determined by the winding ratios of the couplers (transformers or similar arrangement) 264, 268. It is contemplated that that the amount of coupling may be variable, such as user adjustable or based on a control code thereby providing additional compatibility with different baseband chipsets.

The dual coupling port RF coupler shown in FIG. 2B has the benefit of having two coupling modules 254, 258 thereby creating two coupled outputs 266, 276, (which may present signals which are of the same or different values) in addition to the RF pass through output 260. With two coupling modules 254, 258 a coupled output is available for the RF-coupling port and for the RX port thereby allowing for use with different baseband chipset designs. Although shown with two coupling modules 254, 258, it is possible to have additional coupling modules (beyond the two shown in FIG. 2B) thereby providing additional compatibility with additional systems.

FIG. 3A is a block diagram illustrating an example embodiment of a proposed front-end module paired with a digital pre-distortion baseband chipset with a dedicated RF coupling port. As shown, a baseband chipset 304 communicates with a front-end module 308. A baseband transmit port 312 connects to a front-end module transmit input port 316 to receive an outgoing signal from the baseband chipset 304. The port 316 connects to a notch filter 320, which in turn connects to a power amplifier 324. The output of the power amplifier 324 connects to a coupler module 332, such as that shown in FIG. 2B. The power amplifier 324 also provides an output signal or a signal related or proportional to the output of the power amplifier 324 to a power detector 328 which has an opposing terminal connected to a voltage detection pin 330 that provides a monitoring or feedback signal to a V-detect port 364 of the baseband chipset 304.

The RF coupler module 332 (device of FIG. 2B) includes three outputs. One output connects to the transmit receive switch 336, the output of which connects to an antenna. The other output of the transmit receive switch 336 forms the receive path from the antenna (not shown) and connects to a notch filter 352, the output of which connects to a low noise amplifier 348. The output of the low noise amplifier 348 connects to a single pole, double throw switch 344.

The RF coupler module 332 also provides an output to an RF-coupling port 338 to provide a feedback signal to a coupling port 362 of the baseband chipset 304 as shown. The third output of the coupler 332 is provided to the single pole, double throw switch 344. The switch 334 is also connectable to a front-end module receive port 356 and to the low noise amplifier 348 described above. The front-end module receive port 356 is connected to a baseband receive port 360 that is part of the baseband chipset 304.

In this combination, output signals from the amplifier 324 go through the RF coupler 332 and reach the RF-CPL port 338. The coupled signals are sent to the baseband chipset 304 for signal processing. The overall coupling coefficient for the coupler 332 is designed or adjusted precisely for the RF coupler. Relating the elements of FIG. 3B to the coupler of FIG. 2B, the first coupler output corresponds to the first coupling port 266 in FIG. 2B. The coupler output 276 corresponds to the second coupling port 276 in FIG. 2B. The coupler RF input 250 corresponds to the input 250 in FIG. 2B. The coupler output 260 corresponds to the RF through output 260 in FIG. 2B.

FIG. 3B is a diagram illustrating the proposed front-end module paired with a digital pre-distortion baseband chipset that reuses the RX port as the coupling port. In this combination, output signals from the amplifier 324 go through a built-in directional coupler 332 with a well-defined coupling coefficient and then to receive port switch 344, in front of the RX port 356. The coupled signals are then fed to the baseband chipset 360 for signal processing. The receive port switch 344 in front of the RX port 356 is needed to isolate the coupled signals in the transmit (TX) mode from the received signals in RX mode.

In this embodiment, without a dedicated coupling port in the baseband chipset 360, the inputs to the baseband chipset are a combined RX port/coupling 390, a TX port 368, and a voltage detect port 372. The combined RX port/coupling 390 connects to the RX port 356 of the front-end module 308. The TX port 368 connects to the transmit port 316 of the of the front-end module 308. The voltage detect port 372 connects to the voltage detect port 330 of the of the front-end module 308.

In relation to both FIG. 3A and FIG. 3B, the front-end module is compatible with a baseband chipset that includes the separate coupling port (FIG. 3A) or a baseband chipset that includes the coupling port combined with the receive port (FIG. 3B). Other configurations will allow the front-end module to be compatible with other or additional baseband chipsets.

The following two tables (Table 1 & Table 2) shown below illustrate exemplary control code sets which are utilized by two commonly implemented baseband chip sets shown in FIGS. 3A and 3B. The control codes are provided to the front-end module from the baseband chipset or from another source. Some baseband chipsets utilize the control codes structure shown in Table 1, while other baseband chipsets utilize the control codes structure shown in Table 2. Unlike prior art front-end modules, the disclosed front-end module is configured to interpret and function with either code set. This allows a single front-end module to be compatible with numerous different baseband chipsets and the associated control code sets that are associated with each particular baseband chipset. As a result, a single front-end module design is compatible with the numerous different type baseband chipsets. In one embodiment, the pins 1, 2, and 3 of FIGS. 3A and 3B are configured to receive the control codes which are shown in Tables 1 and 2. In other embodiments, the control codes may be provided over a single pin, or any number of different pins. Control logic within the front-end module will receive and process the control codes to generate control signals for use within the front-end module, such that providing the control signals to the power amplifier, low-noise amplifier, and one or more switches.

In the embodiments of FIGS. 3A and 3B, the control logic 384 is shown in the front-end module 308 as being connected to input pins of the front-end module. The control logic 384 generate control outputs that may be provided to the switches 344, 336, amplifiers 348, 324, or other control elements of the front-end module 308. In other embodiments, devices other than control logic may be utilized such as, but not limited to, a processor DSP, ASIC, or controller CPU.

As can be seen in the table, in one or more embodiments, the front-end module may be placed in receive mode, transmit mode, or receive bypass mode. In Table 1, there are two control codes, namely power amplifier (324) enabled (PA_EN) and low-noise amplifier (348) enabled (LNA_EN), which controls activation and de-activation of the power amplifier and low-noise amplifier. In Table 2 there are three control codes, namely power amplifier (324) enabled (PA_EN), control_1, and control_2. The disclosed universal front-end module is able to interpret and operate with the control codes of Table 1 and Table 2. In other embodiments, the front-end module may be configured to communicate with other control code sets.

TABLE 1

| Mode | PA_EN | LNA_EN |
|---|---|---|
| Transmit | High | Low |
| Receive LNA_ON | Low | High |
| Receive Bypass | Low | Low |
| Not Used | High | High |

TABLE 2

| Mode | PA_EN | Control_1 | Control_2 |
|---|---|---|---|
| Transmit | High | Low | Low |
| Receive LNA_ON | Low | High | Low |
| Receive Bypass | Low | High | High |
| Off | Low | Low | Low |

In one method of operation, when the front-end module 308 is connected to a baseband chipset having a coupling port 362 as shown in FIG. 3A, then the coupling signal from the baseband chipset is routed to the coupling port 362. As such, the switch 344 will connect the incoming signal from the amplifier 348 and the switch 344 need not switch to the signal on the first coupling port path 266. As a result, the switch position for switch 344 may remain connected between port 356 and amplifier 348 when the baseband chipset has a coupling port 362.

However, when the front-end module 308 is connected to a baseband chipset without a coupling port as shown in FIG. 3B, then there is no coupling port on the baseband chipset to connect to port 338. In this case, the switch 344 can be controlled to route the first coupling signal, from the first coupling port 266, to the receive port 356, which in turn connects to the baseband chipset as shown. At other times, the switch 344 will route the incoming signal, from the antenna via the switch 366, to the receive port 356. In this manner, the switch 344 is controlled to route either of the incoming signal, from the transmit-receive switch 336, or the first coupling signal to the receive port. As a result, a single front-end module is compatible with various baseband chipset configurations.

The innovation has numerous advantages over the prior art. One such advantage and improvement is that conventional digital pre-distortion-capable front-end modules need to have different variations and configurations to work with different digital pre-distortion baseband chip sets, leading to entirely different products depending on which baseband chipset was in use. This requires extra resources for front-end module vendors to design multiple products and adds complexity in supply chain management for original equipment manufacturers (OEMs) and original design and manufacturers (ODMs) users. The universal design, compatible with multiple different baseband chipsets, disclosed herein is digital pre-distortion baseband chipsets agnostic, which reduces or eliminates the need of multiple versions of similar front-end modules with different coupler designs.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A front-end module for use with a baseband chipset comprising:
an antenna port configured to connect to an antenna;
a transmit-receive switch configured to connect to the antenna port;
a transmit signal path comprising:
an input port configured to receive an outgoing signal;
an transmit amplifier configured to amplify the outgoing signal;
a coupler configured to divert a first portion of the outgoing signal to a transmit-receive switch, a second portion of the outgoing signal to a receive path switch, and a third portion of the outgoing signal to a RF-coupling port;
a receive signal path comprising:
a low noise amplifier configured to receive an incoming signal from the transmit-receive switch;
the receive path switch configured to receive the incoming signal from the transmit-receive switch and the second portion of the outgoing signal from the coupler;
a receive port, connected to the receive path switch, configured to selectively receive an incoming signal from the transmit-receive switch and the second portion of the outgoing signal; and
the RF coupling port connected to the coupler to receive the third portion of the outgoing signal.

2. The module of claim 1 wherein the coupler has an input, RF through output, a RF coupling port output, a receive path switch output, and at least one RC network.

3. The module of claim 1 wherein the second portion of the outgoing signal is a different magnitude than the third portion of the outgoing signal.

4. The module of claim 1 wherein the receive path switch comprises a single pole, double throw switch.

5. The module of claim 1 wherein the front-end module is compatible with baseband chipsets that have a coupling port and baseband chipsets that do not have a coupling port.

6. The module of claim 1 wherein the receive path switch selectively provides the second portion of the outgoing signal to the receive port when the front-end module is connected to a baseband chipset that does not have a coupling port.

7. The module of claim 1 further comprising a controller configured to provide control signals to the receive path switch and the transmit-receive switch.

8. A method for coupling an outgoing signal in a front-end module to a baseband chipset comprising:
receiving an outgoing signal at a transmit port of the front-end module;
amplifying the outgoing signal to create an amplified signal;
processing the amplified signal with a coupler to generating an antenna signal, a RF coupling port signal and a receive port switch signal;
providing the antenna signal to a transmit-receive switch configured to selectively switch the antenna signal to an antenna;
providing the RF coupling port signal to an RF coupling port of the front-end module, the RF coupling port configured to provide the RF coupling port signal to a baseband chipset configured to receive an RF coupling port signal; and
providing the receive port switch signal to a receive port switch, the receive port switch signal configured to selectively provide the receive port switch signal or an incoming signal to a receive port of the front-end module, such that the receive port is configured to connect to the baseband chipset.

9. The module of claim 8 further comprising generating controls signals that control switch positions of the transmit-receive switch and the receive port switch.

10. The module of claim 8 wherein for baseband chipsets that have a baseband chipset coupling port, the RF coupling port of the front-end module is connected to the baseband chipset coupling port and for baseband chipsets that do not have a coupling port, the receive port of the front-end module connects to a baseband chipset receive port.

11. The module of claim 8 wherein the coupler has an input port, as pass through port, a RF coupling port, and a receive path switch port.

12. The module of claim 8 wherein the coupler includes an RC network.

13. A front-end module compatible with two or more different baseband chipsets comprising:
a transmit port configured to receive a transmit signal from a baseband chipset, the transmit signal to be transmitted from the front-end module;
a coupler configured to receive the transmit signal or a modified version of the transmit signal and:
divert a first portion to a transmit-receive switch, which connects to an antenna;
divert a second portion to an RF coupling port as an RF coupling port signal;
divert a third portion to a receive path switch, the receive path configured to carry a received signal received over the antenna;
a RF coupling port configured to receive the RF coupling port signal from the coupler;
a receive port configured to selectively:
present the received signal from the antenna, after processing by the frond-end module, to the baseband chipset; and
present the second portion from the coupler to the baseband chipset.

14. The module of claim 13 the module of claim 13 wherein the coupler has an input and three outputs, such that two of the outputs have different coupling coefficients.

15. The module of claim 13 wherein a receive path that connects to the receive port includes a receive path switch and a low noise amplifier, the receive path switch connects to the coupler and the low noise amplifier, and the low noise amplifier is configured to amplify the received signal.

16. The module of claim 13 wherein the front-end module is compatible with baseband chipsets that have or does not have a baseband chipset coupling port.

17. The module of claim 13 wherein the coupler includes an RC network.

18. The module of claim 13 further comprising a controller configured to provide switch control signals to the receive path switch and the transmit-receive switch.
